(19) United States
(12) Patent Application Publication
(10) Pub. No.: US 2003/0212721 A1
(43) Pub. Date: Nov. 13, 2003

(54) Architecture for performing fast fourier transforms and inverse fast fourier transforms

(75) Inventor: Raj Kumar Jain, Mandarin Gardens (SG)

Correspondence Address: HORIZON IP PTE LTD, 166 KALLANG WAY, 6TH FLOOR, SINGAPORE, 349249, CN

(73) Assignee: Infineon Technologies Aktiengesellschaft

(21) Appl. No.: 10/140,904

(22) Filed: May 7, 2002

(51) Int. Cl. G06F 15/00

(52) U.S. Cl. 708/404

(57) ABSTRACT

A processor for performing fast Fourier-type transform operations is described. Butterfly operations are performed on input values a prescribed number of times, a butterfly operation comprising three multiply operations and a plurality of add operations.

### FIELD OF THE INVENTION

The present invention relates generally to integrated circuits (ICs). More particularly, the invention relates to architectures for performing fast Fourier transform (FFT) and inverse fast Fourier transform (IFFT) operations.

### BACKGROUND OF THE INVENTION

The Discrete Fourier Transform (DFT) is applied extensively in many instrumentation, measurement and digital signal processing applications. The N-point DFT of a sequence x(k) in the time domain, where N=2^{m} and m is an integer, produces a sequence of data X(n) in the frequency domain. The transform equation is as follows:

$$X ( n ) = {\sum }_{k = 0}^{N - 1} x ( k ) {W}_{N}^{n} where n = 0 , 1 , … , N - 1.$$

and the inverse DFT of X(n) can be defined as follows:

$$x ( k ) = \frac{1}{N} {\sum }_{n = 0}^{N - 1} X ( n ) {W}_{N}^{- n}$$

W represents the twiddle factor, where W_{N}=cos (2πk/N)−j sin (2πk/N), and k=_{0, 1, . . .} , (N−1).

Several techniques have been proposed to speed up the DFT computation, one of which is the Fast Fourier transform (FFT) or inverse fast Fourier Transform (IFFT), which exploits the symmetry and periodicity properties of the DFT. The IFFT/FFT has found many real-time applications in, for example, data communications systems where it is used to modulate/demodulate discrete multitone (DMT) or orthogonal frequency division multiplexing (OFDM) waveforms.

FIG. 1 shows an implementation of an N-point inverse Fourier transform using a decimation-in-frequency (DIF) technique. Illustratively, N is set to 8. The DIF technique divides the output frequency sequence into even and odd portions to split the DFTs into smaller core calculations. Other FFT techniques, such as decimation-in-time(DIT), are also useful. The FFT and IFFT computation comprises a series of complex multiplications, known as butterflies (106). Each butterfly computing unit comprises, for example, adders and multipliers.

FIG. 2 shows a block diagram of a basic FFT butterfly 201. The outputs X and Y of each FFT butterfly are typically computed from the inputs A and B, according to the following equations:

$$\begin{matrix}X = A + B \\ = ( {A}_{r} + {B}_{r} ) + j ( {A}_{i} + {B}_{i} ) \\ Y = ( A - B ) * W \\ = ( {C}_{r} + j {C}_{i} ) * ( {W}_{r} + j {W}_{i} ) \\ = ( {C}_{r} * {W}_{r} - {C}_{i} * {W}_{i} ) + j ( {C}_{i} * {W}_{r} + {C}_{r} * {W}_{i} )\end{matrix}$$

where

C=(Aᵣ−Bᵣ)+j(Aᵢ−Bᵢ); and

W=cos (2πk/N)−j sin (2πk/N)

The complex data variables, such as A, B and C, comprise real and imaginary parts, indicated by the subscript “r” and “i” respectively.

The complex multiplication for output Y typically involves four multiply operations and 2 add operations. For an N-point sequence, there are typically N/2 butterflies per stage and log₂N stages. Hence, (4*N/2) log₂N=2N log₂N multiply and N log₂N add operations would be required to compute the FFT. Using one multiplier, the butterfly operation is completed in at least four cycles. If additional multipliers are provided to increase computational efficiency, the size of the chip is increased, which undesirably hinders miniaturization as well as increases the cost of manufacturing.

As evidenced from the above discussion, it is the object of the invention to provide a processor having an improved architecture to perform fast Fourier-type transform operations at higher speeds.

### SUMMARY OF THE INVENTION

The invention relates, in one embodiment, to a processor for performing fast Fourier-type transform operations. In one embodiment, butterfly operations are performed on input values a prescribed number of times, generating modified input values. A butterfly operation comprises three multiply operations and a plurality of add operations, said butterfly operation involving a datapath unit. The modified input values are temporarily stored and fed back to the datapath unit for further computations.

### BRIEF DESCRIPTION OF THE DRAWINGS

FIG. 1 shows an N-point inverse Fourier transform;

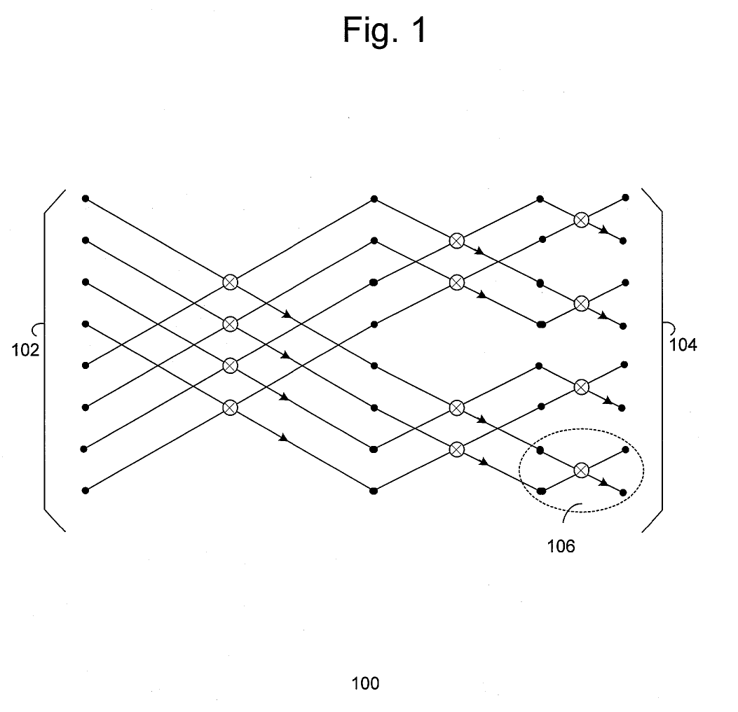

FIG. 2 shows a block diagram of a basic FFT butterfly;

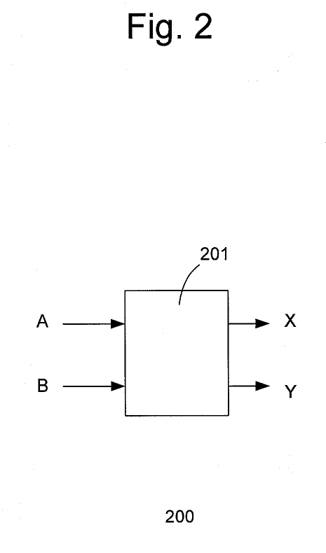

FIG. 3 shows a block diagram of one embodiment of the invention;

FIG. 4 shows the architecture of one embodiment of the invention; and

FIG. 5 shows a timing diagram of the butterfly stage of the FFT, according to one embodiment of the invention.

### PREFERRED EMBODIMENTS OF THE INVENTION

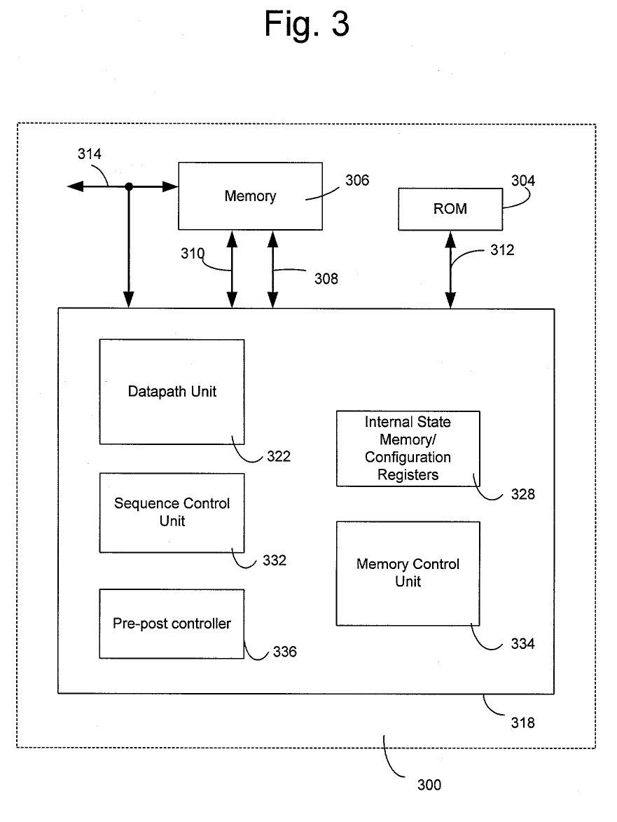

FIG. 3 shows a block diagram of the architecture of an FFT processor 300, according to one embodiment of the present invention. The processor performs FFT operations to convert input data on a time axis to output data on a frequency axis. In addition, the processor may also perform IFFT operations to convert input data on a frequency axis to output data on a time axis using the same computation engine.

In one embodiment of the invention, the processor 300 comprises a read-only memory (ROM) 304 for storing pre-computed constants (e.g. twiddle factors) and a memory unit 306 for storing input data and FFT or IFFT results. Other types of memories are also useful. Input data is transferred to the memory unit 306 via bus 314. Other types of data, for example, configuration and control data, may also be transferred via bus 314. The memory unit is coupled to a computation unit 318 via, for example, buses 308 and 310. Other types of buses are also useful.

During the FFT computation, input values are transferred from the memory unit to the computation unit. The computation unit comprises, for example, a datapath unit 322. The datapath unit comprises, in one embodiment, the hardware required to compute FFT or IFFT butterfly operations on the input values (A and B), generating modified input values (X and Y). In accordance to one embodiment of the invention, the terms of the FFT butterfly equations may be rearranged to reduce space and power consumption. In one embodiment, the real and imaginary components for modified input Y are expanded and rearranged as follows:

$$\begin{matrix}X = A + B \\ = ( {A}_{r} + {B}_{r} ) + j ( {A}_{i} + {B}_{i} )\end{matrix}$$

Yᵣ=(CᵣWᵣ−CᵢWᵢ)=Cᵣ* (Wᵣ+Wᵢ)=D

Yᵢ=(CᵣWᵣ+CᵢWᵢ)=Cᵣ* (Wᵣ−Wᵢ)+D

where

C=(Aᵣ−Bᵣ)+j(Aᵢ−Bᵢ);

W=cos (2πk/N)−j sin (2πk/N); and

D=Wᵢ*(Cᵣ+Cᵢ)

By identifying D as the common term in the computation of the real and imaginary parts of Y, the number of multiply operations may be reduced to only three multiply operations. Hence, a reduction of about 25% in the number of multiply operations is achieved. For an N-point sequence having N/2 butterflies per stage and log₂N stages, only (3N/2) log₂N multiply operations would be required to compute the FFT. Hence, the number of multiply operations is reduced without increasing the number of multipliers, thereby reducing power and chip space requirements.

Similarly, for each IFFT butterfly having two inputs A and B and two modified inputs X and Y, the terms of the equations may be rearranged to identify the common term D, as follows:

X=(Aᵣ+Bᵣ)+j(Aᵢ+Bᵢ)

Yᵣ=Cᵣ*(Wᵣ−Wᵢ)+D

Yᵢ=Cᵢ*(Wᵣ+Wᵢ)−D

where

C=(Aᵣ−Bᵣ)+j(Aᵢ−Bᵢ)

W=cos (2πk/N)+j sin (2πk/N); and

D=Wᵢ*(Cᵣ+Cᵢ)

Hence, the number of multiply operations is reduced by about 25%, resulting in a significant reduction in chip space and power requirements.

In one embodiment, the datapath unit includes at least one multiplier and a plurality of adders. A sequence control unit 332 may be included to control the flow of data in the datapath unit. After the butterfly computation, the modified input values are fed back to the datapath unit a prescribed number of times until the FFT or IFFT computation is completed. The final results are written back to the memory unit 306. Memory access is controlled by, for example, the memory control unit 334. There is further included, in one embodiment, configuration registers for storing configuration data and an internal state memory 328 for storing intermediate results.

In one embodiment, the computation unit 318 includes a pre-processing and post-processing controller 336 coupled to the datapath processor 322 for further reducing the computational time complexity. The pre/post-processing controller rearranges the data in pre-processing and post-processing stages to reduce the number of butterflies required per stage.

The FFT may be modified, in one embodiment, to compute the real FFT instead of the complex FFT, making use of inherent symmetry properties. The input signal is rearranged to remove unnecessary computations, by separating it into N/2 even points and N/2 odd points, using an interlaced decomposition. The even points are placed into the real part of the time domain signal, while the N/2 odd points are placed in the imaginary part. An (N/2)-point FFT is then computed, requiring about half the time for an N-point FFT. The resulting frequency is then separated by even and odd decomposition, resulting in the frequency spectra of two interlaced time domain signals. These 2 frequency spectra are then combined into a single spectrum, during the final post-processing stage of the FFT.

In one embodiment, the FFT comprises butterfly operations and post-processing operations performed in a post-processing stage. During the final stage of post-processing of one embodiment of the invention, the final modified inputs X and Y are computed using three-multiply-cycle operations by identifying the common factor D, as follows:

Let E=A+B and F=A−B.

Therefore,

E=(Aᵣ+Bᵣ)+j(Aᵢ+Bᵢ)

F=(Aᵣ₋Bᵣ)+j(Aᵢ−Bᵢ)

Let

D=Wᵢ*(Fᵣ+Eᵢ)

G=Eᵢ*(Wᵣ−Wᵢ)+D

H=Fᵣ*(Wᵣ+Wᵢ)−D

Then

Xr=[Eᵣ+G]/2

Xi=[Fᵢ−H]/2

Yr=[Eᵣ−G]/2

Yi=[−Fᵢ−H]/2

where W=cos (πk/N)−j sin (πk/N)

By including a pre-processing and post-processing controller, only (N/2)-points need to be computed in each stage, each stage comprising only (N/4) butterflies. The total number of stages, including the post-processing stage, is log₂(N/2)+1. The total number of butterflies is (N/4) (log₂(N/2)+1), hence achieving a reduction of about 50% in the total number of butterflies required.

Similarly, according to one embodiment of the invention, the IFFT comprises pre-processing operations performed in a pre-processing stage, and butterfly operations. Assuming the data comprises real points, the data is rearranged into two sets during the pre-processing stage. During the first stage of pre-processing, the outputs X and Y are computed as follows:

Let E=A+B and F=A−B.

Therefore,

E=(Aᵣ+Bᵣ)+j(Aᵢ+Bᵢ)

F=(Aᵣ−Bᵣ)+j(Aᵢ−Bᵢ)

Let

D=Wᵢ*(Fᵣ+Eᵢ)

G=Eᵢ*(Wᵣ+Wᵢ)−D

H=Fᵣ*(Wᵣ−Wᵢ)+D

Then

Xr=[Eᵣ−G]/2

Xi=[Fᵢ+H]/2

Yr=[Eᵣ+G]/2

Yi=[−Fᵢ+H]/2

where

W=cos (πk/N)+j sin (πk/N)

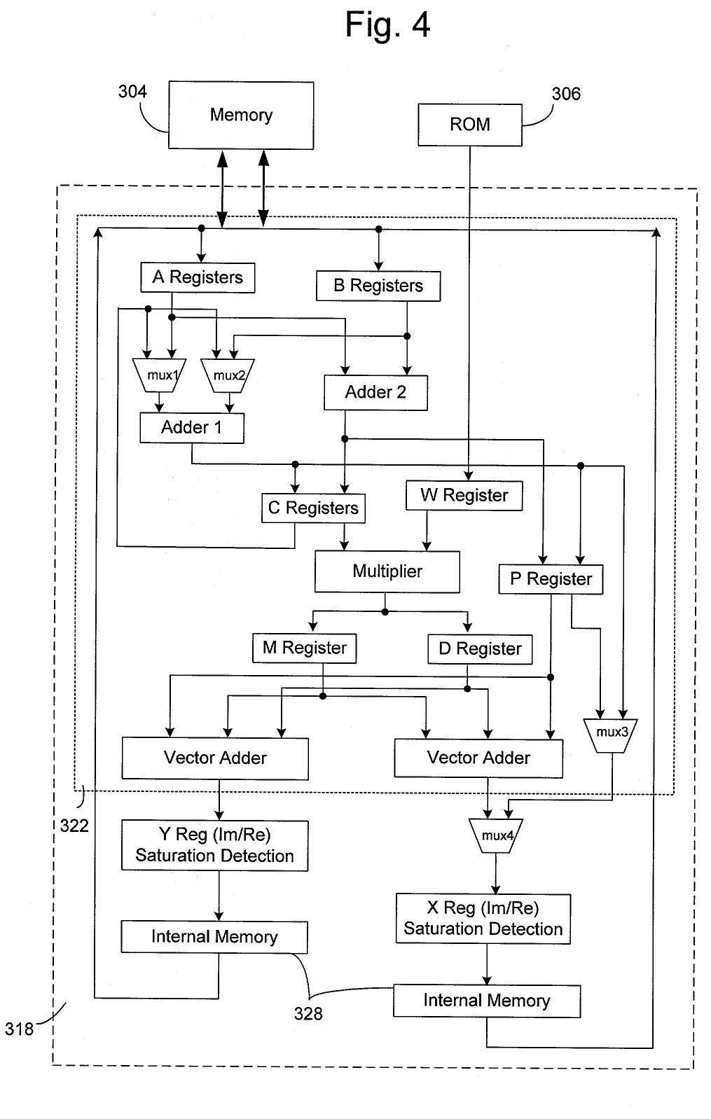

FIG. 4 shows the architecture of a FFT/IFFT processor according to one embodiment of the invention in greater details. The processor computes the final FFT results X and Y using three-multiply-cycle butterflies, according to the aforementioned equations. The same architecture may also be used to compute IFFT results. In one embodiment, support for pre-processing and post-processing is included in the architecture.

The FFT processor comprises a computation unit 318 coupled to a memory unit 306 and ROM 304. The computation unit comprises, for example, a datapath unit 322. The datapath unit comprises at least one multiplier and a plurality of adders. In one embodiment, first registers (A Registers) and second registers (B Registers) are provided to temporarily store first and second complex (i.e. real and imaginary) input values retrieved from the memory unit. A third register (W Register) may be provided to temporarily store the complex twiddle factor W, as well as the pre-computed sum and difference of the real and imaginary parts of W retrieved from the ROM. In one embodiment, intermediate registers (e.g. C Registers, P Register, M Register and D Register) are provided to store the intermediate results.

A butterfly operation is performed on A Registers and B Registers a prescribed number of times, generating modified first real and imaginary input values (X) and modified second real and imaginary input values (Y). After the butterfly computation, the first and second modified input values (X and Y) are temporarily stored in, for example, X and Y Registers respectively. In one embodiment, if saturation has occurred, rounding off is performed. An internal memory may be provided to temporarily store X and Y results before feeding back to first and second registers (A Registers and B Registers) for subsequent operations. Other configurations of hardware are also useful. Alternatively, additional hardware may be added.

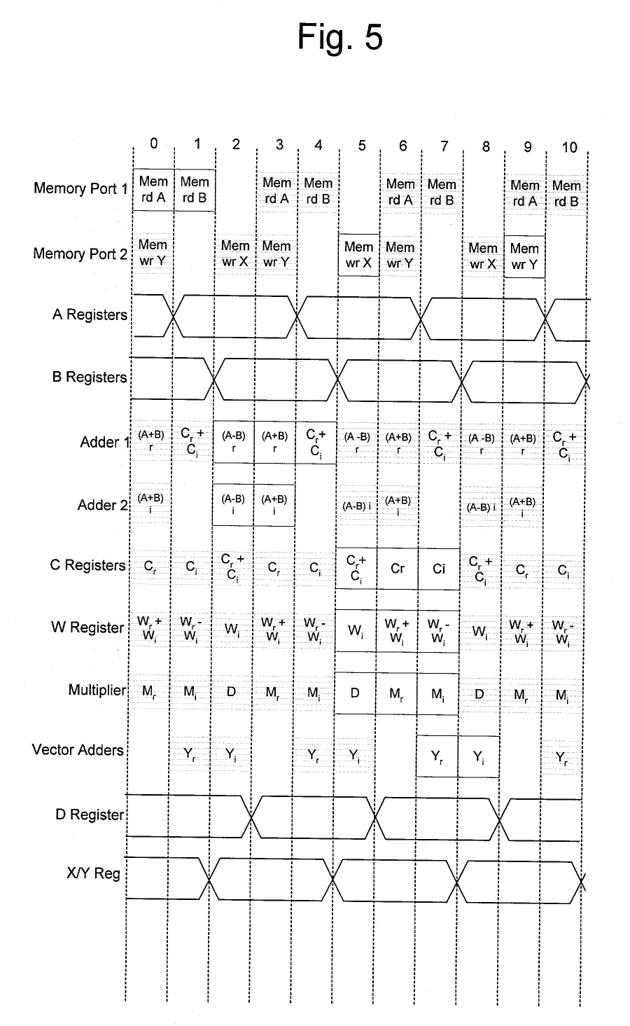

FIG. 5 shows the timing diagram of the butterfly stage of the FFT processor, according to one embodiment of the invention. The diagram illustrates a pipelined operation of the FFT computation. A similar pipeline design may be used for the IFFT computation. Other types of pipeline designs are also useful. In one embodiment of the invention, the complex multiplication for the FFT butterfly may be completed in only three cycles using a single multiplier.

Referring to FIG. 5, the complex input data A is loaded via Memory Port 1 from the memory unit into the first registers (A Registers) during cycle 0. During cycle 1, the complex input data B is loaded via Memory Port 2 from the memory unit into the second registers (B Registers). A single memory port for both data A and B is also useful.

During cycle 2, the second registers are subtracted from the first registers, generating first and second intermediate results (Cᵣ and Cᵢ). In one embodiment, Adder 1 produces the difference of the real parts of A and B (Cᵣ=Aᵣ−Bᵣ). Adder 2 produces the difference of the imaginary parts (Cᵢ=Aᵢ−Bᵢ). During cycle 3, the first registers (A Registers) are added to the second registers (B Registers) to generate X. For example, Adder 1 produces the sum of the real parts (Xᵣ=Aᵣ+Bᵣ) and the Adder 2 produces the sum of the imaginary parts (Xᵢ=Aᵢ+Bᵢ). The real and imaginary parts of X are loaded into the X Registers. After saturation detection and rounding off, the final X results are loaded into, for example, an internal memory before writing to the memory unit in cycle 5.

During cycle 4, the first and second intermediate results (Cᵣ and Cᵢ) are added, generating a sum of the intermediate results. In one embodiment, Adder 1 forms the sum (Cᵣ+Cᵢ). In one embodiment of the invention, the multiplier performs a multiplication every cycle and has been fully utilized to improve performance. Three multiply operations are performed to generate first, second and third partial products D, Mᵣ (partial Yᵣ) and M_{I} (partial Yᵢ), where:

D=(Cᵣ+Cᵢ)*Wᵢ;

Mᵣ=Cᵣ(Wᵣ+Wᵢ); and

Mᵢ=Cᵢ(Wᵣ−Wᵢ).

The imaginary part of a twiddle factor W is loaded from memory (e.g. ROM) to a third register (W Register). The multiplier performs a multiply operation between W Register and the sum (Cᵣ+Cᵢ) stored in the C Registers, generating the first partial product D and storing it in, for example, a D Register.

In one embodiment, the twiddle sum (Wᵣ+Wᵢ) and twiddle difference (Wᵣ−Wᵢ) of the real and imaginary parts of the twiddle factor are pre-computed and stored in the memory to speed up the computation. The twiddle sum is loaded into the W Register during cycle 6. The multiplier A performs a multiply operation between the W Register and the first intermediate result Cᵣ stored in the C Registers, generating the second partial product Mᵣ. During cycle 7, the Vector Adder computes the modified second real input value (Yᵣ) by subtracting said first partial product D from said second partial product Mᵣ (i.e. Yᵣ=Mᵣ−D)

During the same cycle 7, the twiddle factor difference (Wᵣ−Wᵢ) is fetched from memory and loaded into the W Register. The multiplier then forms the third partial product Mᵢ by performing a multiply operation between the W Register and the second intermediate result Cᵢ stored in the C registers. During the next cycle 8, the imaginary part of Y may be formed by adding the first partial product D and the third partial product Mᵢ. For example, a vector adder may be used to form the sum of Mᵢ and D (Yᵢ=Mᵢ+D). Finally, the real and imaginary parts of Y are tested for saturation, rounded off if necessary and written to memory at cycle 9.

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

What is claimed is:

1. A method for performing fast Fourier-type transform operations using a processor, said method comprising the steps of:
loading first real and imaginary input values into first registers, and second real and imaginary input values into second registers;
performing a butterfly operation on said first registers and said second registers a prescribed number of times, generating modified first real and imaginary input values and modified second real and imaginary input values, said butterfly operation comprising three multiply operations and a plurality of add operations, said butterfly operation involving a datapath unit comprising at least one multiplier and a plurality of adders; and
temporarily storing said modified first and second input values from said datapath unit and feeding back said modified first and second input values to said first and second registers.

2. The method of claim 1 further comprising the step of rounding off said modified first and second input values when saturation has occurred.

3. The method of claim 1 wherein the step of performing a plurality of butterfly operations comprises the steps of:
adding said first registers to said second registers to generate said modified first real and imaginary input values; and
performing three multiply operations to generate said modified second real and imaginary input values.

4. The method of claim 3 wherein the step of performing three multiply operations comprises:
performing three multiply operations to generate first, second and third partial products;
subtracting said first partial product from said second partial product to generate said modified second real input values; and
adding said first partial product and said third partial product to generate said modified second imaginary input values.

5. The method of claim 4 further comprising pre-computing a sum of real and imaginary parts of a twiddle factor, generating a twiddle sum and storing said twiddle sum.

6. The method of claim 5 further comprising pre-computing a difference of said real and imaginary parts of a twiddle factor, generating a twiddle difference and storing said twiddle difference.

7. The method of claim 6 wherein the step of performing three multiply operations comprises the steps of:
loading said imaginary part of said twiddle factor into a third register;
subtracting said second registers from said first registers to generate first and second intermediate results;
adding said first intermediate and said second intermediate results to generate a sum of said intermediate results;
performing a multiply operation between said third register and said sum of said intermediate results, generating said first partial product;
loading said twiddle sum into said third register;
performing a multiply operation between said third register and said first intermediate result, generating said second partial product;
loading said twiddle difference into said third register; and
performing a multiply operation between said third register and said second intermediate result, generating said third partial product.

8. The method of claim 3 wherein the step of performing three multiply operations comprises:
performing three multiply operations to generate first, second and third partial products;
adding said first partial product and said second partial product to generate said modified second real input values; and
subtracting said first partial product from said third partial product to generate said modified second imaginary input values.

9. The method of claim 1, wherein said fast Fourier-type transform operations comprise fast Fourier transform operations, said fast Fourier transform operations comprising butterfly operations and post-processing operations.

10. The method of claim 1, wherein said fast Fourier-type transform operations comprise inverse fast Fourier transform operations, said inverse fast Fourier transform operations comprising pre-processing operations and butterfly operations.

11. A FFT processor for performing fast Fourier-type transform operations, the processor comprising:
a computation unit comprising first registers for storing first real and imaginary input values, second registers for storing second real and imaginary input values, and a datapath unit, said datapath unit performs butterfly operations on said first registers and said second registers a prescribed number of times, generating modified first real and imaginary input values and modified second real and imaginary input values, said butterfly operation comprising three multiply operations and a plurality of add operations, said datapath unit comprising at least one multiplier and a plurality of adders.

12. The FFT processor of claim 11 further comprising a sequence control unit coupled to said datapath unit, said sequence control unit controlling flow of data in said datapath unit.

13. The FFT processor of claim 12 further comprising a pre-processing and post-processing controller for reducing the number of butterflies required.
